(19) United States
(12) Patent Application Publication
(10) Pub. No.: US 2002/0171256 A1
(43) Pub. Date: Nov. 21, 2002

(54) Dash-mounting glare filter

(76) Inventor: Herbert Ward, Houston, TX (US)

Correspondence Address: Randal D. Homburg, 4th Floor, 50 Penn Place, Oklahoma City, OK, 73118-1803, US

(21) Appl. No.: 09/854,955

(22) Filed: May 15, 2001

(51) Int. Cl. B60J 3/06

(52) U.S. Cl. 296/97.7

(57) ABSTRACT

The invention is a glare filter removably mounted to the dash of an automobile to position and direct the filter into areas on the windshield where no other glare filter or visor is located protecting the driver from direct glare and sunshine or from reflected glare or sunshine while operating the vehicle.

### CROSS REFERENCE TO RELATED APPLICATIONS

None

### I. BACKGROUND OF THE INVENTION

1. Field of Invention

The invention is a glare filter removably mounted to the dash of an automobile to position and direct the filter into areas on the windshield where no other glare filter or visor is located protecting the driver from direct glare and sunshine or from reflected glare or sunshine while operating the vehicle.

2. Description of Prior Art

The following United States patents were discovered and are disclosed within this application for utility patent. All relate to sun visors or screens for automobile use or devices mounting within the interior of an automobile for the support of an object.

The current invention utilizes a gooseneck arm as found in U.S. Pat. No. 5,690,307 to Joyce, used to mount and install a CD player to the automobile floor, and U.S. Pat. No. 4,842,174 to Sheppard, used to mount a mobile telephone to the floor of an automobile. A dash mounted accessory holder is disclosed in U.S. Pat. No. 4,105,246 to Trumbull, the lid of the device serving as a glare deflector and a defroster deflector, the device having a storage compartment under the lid. A shock resisting mounting plate is disclosed in U.S. Pat. No. 5,740,995 to Richter which dampens vibration and resists shock movement to the object resting on its top, the device mounting to a dash or a console in an automobile or a boat.

Several sun shields are disclosed having a variety of features. In U.S. Pat. No. 5,016,937 to White, the device is a retractable sheet of opaque material like a window shade, with a hook and loop anchor on the dash to maintain the extension of the sheet of material. A roll-up sun shield for when the vehicle is not in use is disclosed in U.S. Pat. No. 4,828,319 to Benson, the device protecting the entire interior of a car when extended from damaging and harmful UV and sun. A dashboard and side window screen is provided in U.S. Pat. No. 5,033,786 to Bickford, the device being folded at an acute angle and inserted in the window groove of a vehicle or resting open on the dashboard, the device also having a “help” logo for alerting passing motorist of a need for assistance.

A retractable sun blocking screen incorporated into the sun visor of a vehicle is disclosed in U.S. Pat. No. 5,064,238 to Mohtasham for protecting a dashboard from sun while the vehicle is parked. An extension to a sun visor mounted to the sun visor, having a retractable arm mounting apparatus is disclosed in U.S. Pat. No. 5,622,401 to Ip. Another clip-on sun shield is disclosed in U.S. Pat. No. 5,575,522 to Robinson having a pair of clips to attach the device to the automobile sun visor.

### II. SUMMARY OF THE INVENTION

The primary objective of the invention is to provide a movable glare shield removably mounted to a vehicle dashboard having a screen attached to a flexible arm for the positioning of the glare shield wherever desired by the user. While other devices provide sun screens or visors mounting to other parts of an automobile, including the roof, the windows and windshields and other sun visors, the present device mounts to the dashboard, when in use, and provides a full range of coverage to the front wind shield protecting the driver from glare using an opaque polarized shield, fully stored away when not being used.

### III. DESCRIPTION OF THE DRAWINGS

The following drawings are submitted with this utility patent application.

FIG. 1 is a perspective view of the device installed on a vehicle dashboard.

FIG. 2 is a view of the removable dashboard mounting plate on the base end of the flexible rod and the dashboard mounting bracket.

FIG. 3 is a view of one embodiment of the polarized shield attached to the shield clip on the upper end of the flexible rod.

### IV. DESCRIPTION OF THE PREFERRED EMBODIMENT

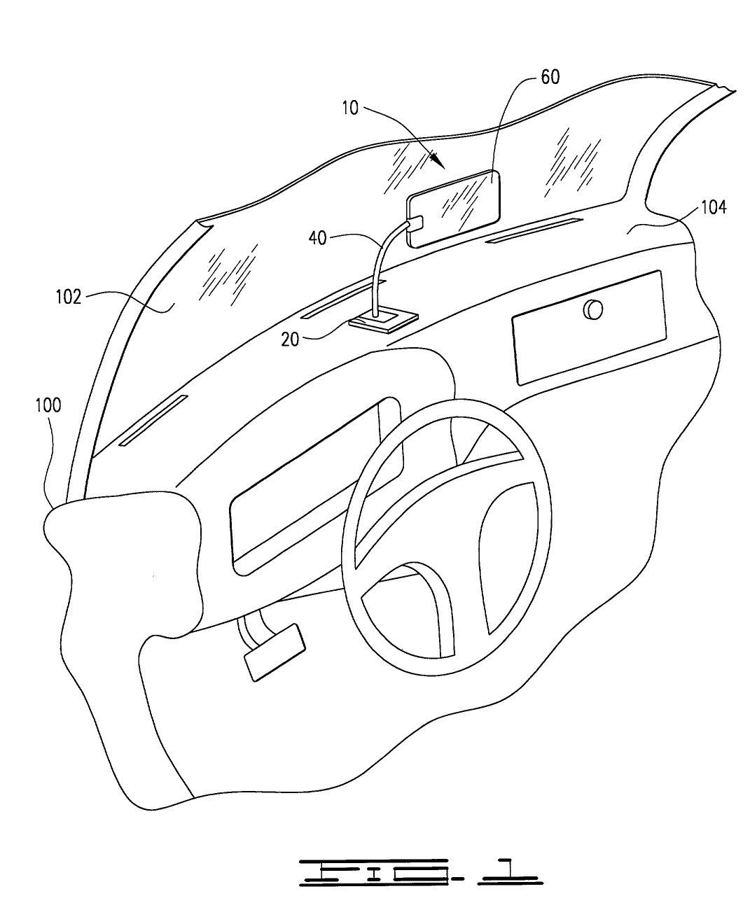

The invention, as shown in FIGS. 1-3 of the drawings, is a fully adjustable, dash-mounted glare shield for the reduction of direct or reflected glare through the front windshield 102 of the automobile 100 attaching to a front dashboard 104 of the automobile, the device 10 comprising a dashboard mounting plate 20, a flexible rod 40, and at least one detachable polarized glare shield 60.

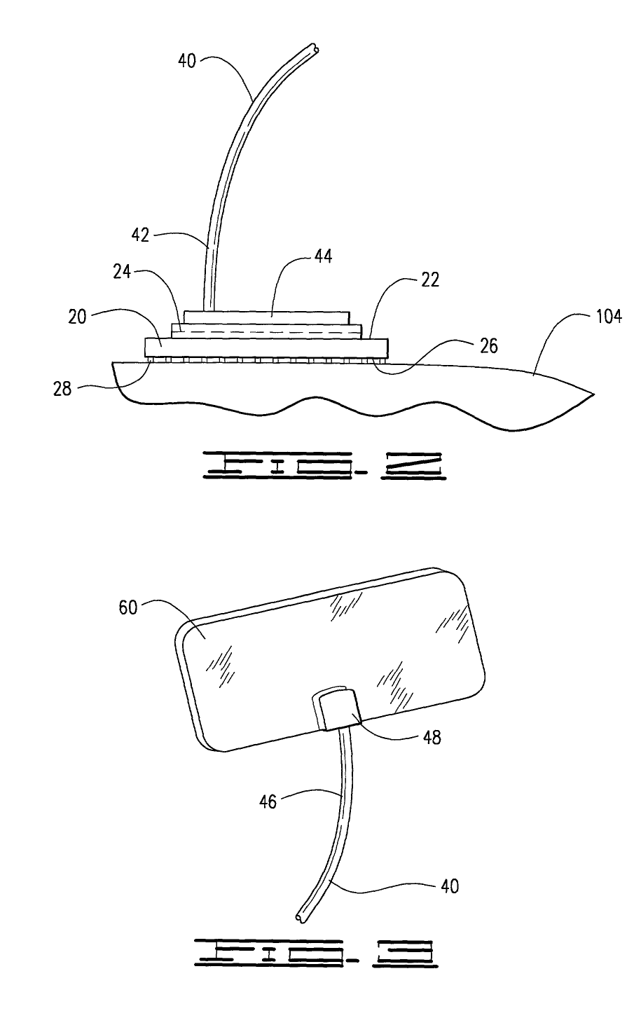

The flexible rod 40 has a base end 42, as shown in FIG. 2 of the drawings, to which is attached a dashboard mounting bracket 44. The flexible rod 40 also has an upper end 46 affixed to a shield clip 48, as shown in FIG. 3 of the drawings. The flexible rod 40 should be primarily rigid to maintain a chosen position, but should be somewhat bendable to enable positioning of the flexible rod in all directions enabling the device to be adjusted to multiple varied locations on the windshield.

The dashboard mounting bracket 44 is insertable into the dashboard mounting plate 20, the dashboard mounting plate 20 having an upper surface 22 to which a first attaching means 24 is provided to receive the dashboard mounting bracket 44, as seen in FIG. 2 of the drawings. A lower surface 26 is also provided on the dashboard mounting plate 20, having a second attaching means 28 attaching the lower surface 26 to the automobile's dashboard 104.

The polarized glare shield 60 may be provided in several embodiment of varying sizes, shapes and intensities of polarization and tint. One embodiment may provide a rectangular polarized glare shield 60, as shown in FIG. 3 of the drawings. The polarized glare shield 60 is attached to the upper end 46 of the flexible rod 40 by the shield clip 48 anywhere on the polarized glare shield 60 to suit the driver's needs for glare reduction.

The driver may remove the dashboard mounting bracket 44 from the dashboard mounting plate 20 when needed or in dark driving conditions, although the device 10 may be used to reduce the glare of headlights during night driving. By detaching the polarized glare shield 60 from the flexible rod 40, the device 10 is reduces to a size suitable for compact storage. Preferably suited as the placement location for the dashboard mounting plate 20 would be the center of the dashboard 104 providing the maximum adjustable coverage range to the windshield.

The device may be installed by attaching the dashboard mounting plate 20 to the dashboard 104 by the second attaching means 28, connecting the dashboard mounting bracket 44 to the upper surface 22 of the dashboard mounting plate 20 by way of the first attaching means 24, attaching the selected polarized glare shield 60 to the shield clip 48 at the upper end 46 of the flexible rod 40, and moving the attached polarized glare shield 60 to the desired location to reduce direct or indirect glare to the driver.

While the invention has been particularly shown and described with reference to a preferred embodiment thereof, it will be understood by those skilled in the art that changes in form and detail may be made therein without departing from the spirit and scope of the invention.

What is claimed is:

1. A fully adjustable, dash-mounted glare shield for the reduction of direct or reflected glare through the windshield of an automobile, the device comprising:
a. a dashboard mounting plate attached to a front dashboard of the automobile;
b. a flexible rod attached to the dashboard mounting plate; and
c. at least one detachable polarized glare shield attached to the flexible rod.

2. A fully adjustable, dash-mounted glare shield for the reduction of direct or reflected glare through the windshield of an automobile, the device comprising:
a. a dashboard mounting plate having an upper surface having a first attaching means and a lower surface having a second attaching means, the first attaching means attached to a front dashboard of the automobile;
b. a flexible rod, having a base end and an upper end, the base end having a dashboard mounting bracket attaching to the first attaching means on the upper surface of the dashboard mounting plate; and
c. at least one detachable polarized glare shield attached to a shield clip affixed on the upper end of the flexible rod.

3. The device, as disclosed in claim 2, wherein the flexible rod should be primarily rigid to maintain a chosen position, but should be somewhat bendable to enable positioning of the flexible rod in all directions enabling the device to be adjusted to multiple varied locations on the windshield.

4. The device, as disclosed in claim 2, wherein the polarized glare shield may be provided in several embodiment of varying sizes, shapes and intensities of polarization and tint.
